(19) United States
(12) Patent Application Publication
(10) Pub. No.: US 2008/0023958 A1
(43) Pub. Date: Jan. 31, 2008

(54) CONNECTOR

(75) Inventors: Yosuke Sakai, Fukuroi-shi (JP); Ichiro Kitani, Fukuroi-shi (JP); Shigeaki Funamura, Fukuroi-shi (JP)

Correspondence Address: TYCO HEALTHCARE - EDWARD S. JARMOLOWICZ, 15 HAMPSHIRE STREET, MANSFIELD, MA, 02048, US

(73) Assignee: TYCO HEALTHCARE GROUP LP, Mansfield, MA (US)

(21) Appl. No.: 11/829,515

(22) Filed: Jul. 27, 2007

(30) Foreign Application Priority Data
Jul. 27, 2006 (JP) 2006-204773

(51) Int. Cl. F16L 41/00

(52) U.S. Cl. 285/133.21

(57) ABSTRACT

A connector for switching communication-to-interception states between liquid transfusion tubes. The connector comprises a connector body, a seal member, and a valve with an improved sealing which limits contact with air and minimizes generation of bacteria during medical use.

### FIELD OF THE INVENTION

The invention relates to a connector for switching communication-to-interception states between liquid transfusion tubes, which is coupled to a plurality of liquid transfusion tubes and the like of medical use.

### BACKGROUND OF THE INVENTION

In conventional practice, a predetermined liquid medicine or serum and the like are supplied internally to a patient by using a plurality of liquid transfusion tubes. In such a case, the tubes are connected by using a connector such as a medicinal plug. The connector includes a plurality of branched tubes to which a rubber plug that can be penetrated by a injection needle is attached to the inner of a predetermined branch tube (for example, see Japanese Unexamined Patent Publication No. 2000-16437).

This connector comprises two branched tubes horizontally extending from an injector body portion and an injector connecting port formed at the upper portion of the injector body part. Also, the injector connecting port is provided with a seal valve having an insertion part passing through from the upper side to the lower side thereof. Therefore, by inserting a twist locking injector into the insertion part of the seal valve, the twist locking injector can communicate with the internal body of the connector. By this, the liquid medicine can be injected from the twist locking injector to the inner part of the body of the connector or, conversely, the liquid medicine can be extracted from the body of the connector.

In the conventional connector mentioned above, the body of the connector is occluded by inserting the twist locking injector into the slit-like insertion part of the seal valve to so that the twist locking injector can communicate with the inner of the body of the connector, and then pulling out the twist locking injector of the insertion part to occlude the insertion part. However, when the slit-like insertion part is provided with such a seal valve, it is difficult to occlude the body of the connector while being at a high level of liquid tightness and, thus, there is a risk of liquid leakage occurring at the insertion part. Further, the risk of generation of bacteria at the inner surface of the insertion part by contacting or accumulating air thereon is also increased.

In the light of these aforementioned problems, the object of the invention is to provide a connector with improved sealing capability and suppression of the generation of the bacteria through contact with air.

### SUMMARY OF THE INVENTION

In order to achieve the above object, the configuration of the connector according to the current invention is that the connector comprises a connector body including a chamber part and a plurality of branch tubes extended from said chamber part in different directions having at least one upper branch tube upwardly extended from the chamber part; and a seal member connected to one predetermined branch tube of the plurality of branch tubes for opening and closing the predetermined branch tube, the seal member being comprised of a fixing piece fixed to a predetermined portion at the opening side of the predetermined branch tube, and a seal member body coupled to the fixing piece for occluding the opening portion of the predetermined branch tube as well as for communicating the inner of the chamber with the inner of a connecting tube by inserting the connecting tube from the opening of the predetermined branch tube to the inside thereof to push the seal member body into the inside of the predetermined branch tube.

### BRIEF DESCRIPTION OF THE DRAWINGS

FIG. 1 is a plane view illustrating the connector of one embodiment in accordance with the invention;

FIG. 2 is a front view of the connector;

FIG. 3 is a side view of the connector;

FIG. 4 is a cross sectional view of the connector;

FIG. 5 is a cross sectional view of the connector of FIG. 4 in which the male luer part is inserted into the seal member; and

FIG. 6 is a cross sectional view illustrating the relation between the body and the valve of the connector.

### DETAILED DESCRIPTION OF THE INVENTION

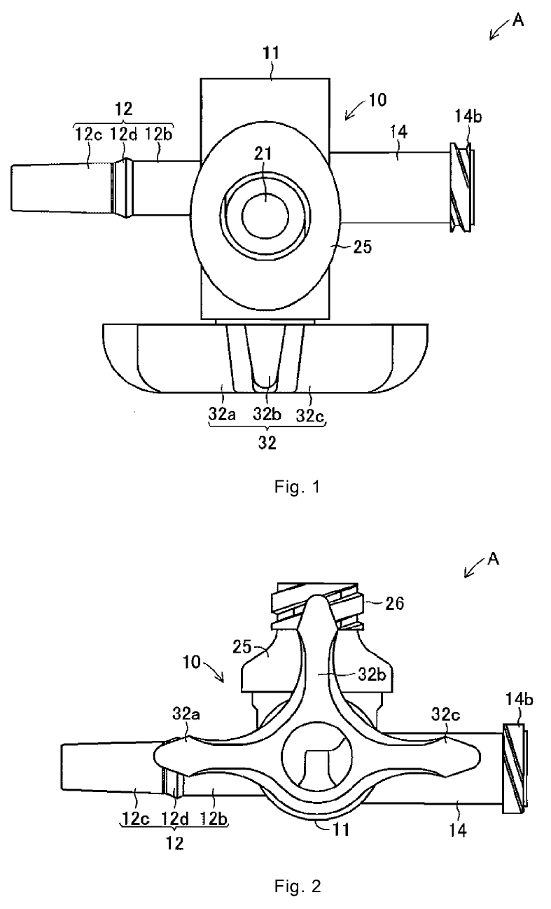

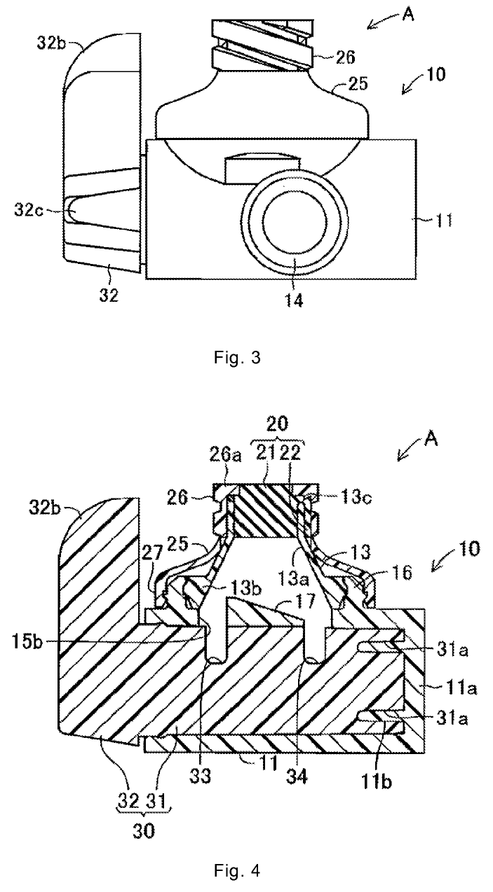

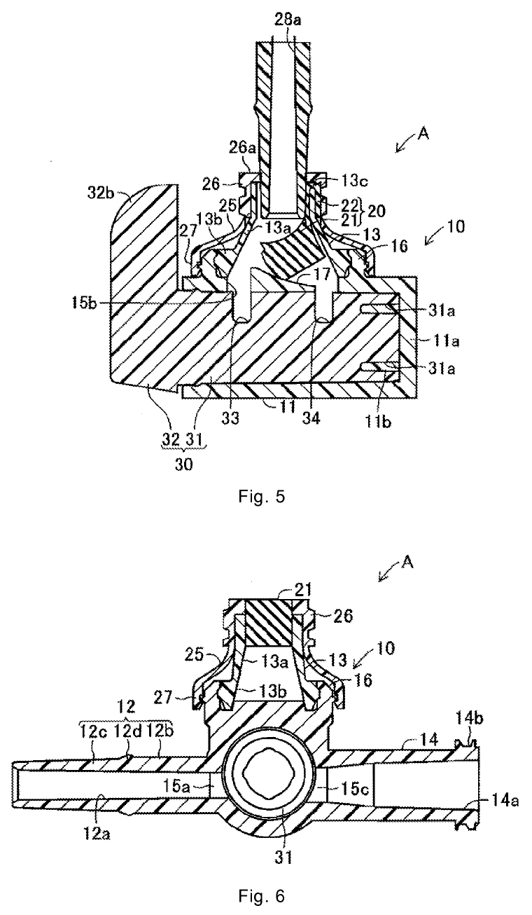

In one embodiment, the connector in accordance with the invention is described in detail with the reference to the drawings as follows. FIGS. 1 to 3 show a connector A of the same embodiment in accordance with the invention wherein the connector A comprises a seal member 20 (see FIGS. 4 and 5) mounted within the connector body 10, a cap member 25 and a valve 30. Also the connector body 10 includes a cylindrical chamber part 11 having an axial length that is shorter than the radial length and three branch tubes comprising a downstream branch tube 12 connected perpendicularly to the outer peripheral surface of the chamber part 11, an upper branch tube 13 and an upstream branch tube 14.

The chamber part 11, as shown in FIGS. 4 and 5, is disposed with the axial direction in the longitudinal direction (lying from the right to the left in FIGS. 4 and 5) and formed into a generally cylindrical shape with the rear closed, and, a ring shaped engagement part 11b forwardly extended from the inner surface of a rear wall 11a of the chamber part 11 with the predetermined space apart from the inner peripheral surface of the chamber part 11. Further, communication holes 15a, 15b and 15c (see FIGS. 4 to 6) are provided at the generally central region of the chamber part 11 in the axial direction. Among these communication holes 15a, 15b and 15c, the communication hole 15b is formed such that the central position thereof is slightly deviated toward the front side from the central parts of other communication holes 15a and 15c.

Moreover, the downstream branch tube 12 adjoins the portion in the chamber part 11 to which the communication hole 15a corresponds. The inside of the chamber part 11 and the flow path 12a formed within the downstream branch tube 12 communicate with each other through the communication hole 15a. Additionally, the communication hole 15b has a diameter greater than that of the communication holes 15a or 15c. At the outer peripheral portion of the communication hole 15b, on the outer peripheral surface of the chamber part 11, a generally ring shaped collar 16 to attach the upper branch tube 13 is provided.

Further, at both right and left sides of the inner peripheral surface of the communication hole 15b, a guide part 17 for partitioning the communication hole 15b into front and rear sides. The upper surface of the guide part 17 is formed into a curved surface having a front side at a high position and the height of the surface is gradually lowered as it approaches the rear side generally along an arc. The upstream branch tube 14 is aligned with the communication hole 15c. Further, the inside of the chamber part 11 and the flow path 14a formed within the upstream branch tube 14 communicate with each other through the communication hole 15c.

The downstream branch tube 12 is integrally formed with the chamber part 11 and comprises a basal end part 12b in the chamber part 11 side and a male luer part 12c formed so as to be narrower than the basal end part 12b at the tip end side. The male luer part 12c is tapered such that the tip end side portion is narrower than the basal end part 12b side portion. Then, at the boundary between the basal end portion 12b and the male luer part 12c at the outer peripheral surface of the downstream branch tube 12, projections 12d for engagement are formed along the periphery.

The upper branch tube 13 is constructed to be a generally short cylindrical body having a diameter that is gradually reduced along the height from the lower end to the upper end. The lower end periphery 13b, formed to be thick, is engaged with the inner peripheral surface of the opening edge for connecting to collar 16 so as to secure it to the chamber part 11. Also, to the rear portion at the upper end opening of the upper branch tube 13, a notch part 13c is formed and the inner surface of the upper branch tube 13 is formed into a flow path 13a for the flow of a liquid such as medicinal liquid therethrough. Further, a cap member 25 for fixing the seal member 20 with the upper branch tube 13 is attached to the outer periphery of the upper branch tube 13.

The cap member 25 includes an upper portion 26 that is formed into a generally cylindrical shape having a short length and a dimension set to be capable of engagement with the outer periphery of the upper end opening of the upper branch tube 13. A lower portion 27 is formed into a generally cylindrical shape having a short length and a dimension set to be capable of engagement with the outer peripheral surface of the opening edge for connecting collar 16. Also, the diameter of the cap member 25 is gradually reduced from the lower side to the upper side between the upper portion 26 and the lower portion 27. Therefore, the cap member 25 is formed into a generally cap shape having a short length and an elliptical shape having a longer length in the direction from the front to the rear in the plan view as shown in FIG. 1.

The cap member 25 is detachably mounted to the connector body 10 by engaging the upper portion 26 with the outer peripheral surface of the upper end opening of the upper branch tube 13 and engaging the inner peripheral surface of the lower portion 27 with the outer peripheral surface of the opening edge for connecting collar 16. Further, a ring-like ceiling part 26a is extended from the upper end of the upper portion 26 to the inside of the cap member 25. Thus, a hole is formed at the center of the ceiling part 26a. Accordingly, the seal member 20 is secured by mounting this cap member 25 to the upper branch tube 13.

The seal member 20 is comprised of an elastic member such as natural rubbers, synthetic rubbers or elastomers and includes a seal member body 21 of a thick disk-like shape and a fixing piece 22 of band-like shape coupled to the rear upper end of the seal member body 21. Further, as shown in FIG. 4, the seal member body 21 is pushed into the upper end opening of the upper branch tube 13 while the coupled portion of the seal member body 21 and the fixing piece 22 in the seal member 20 are positioned within the notch part 13c whereby the seal member 20 is attached to the upper branch tube 13. Then, by the attachment of the cap member 25 to the upper branch tube 13 in that condition, the seal member 20 is secured by the upper branch tube 13 and the cap member 25.

That is to say, the fixing piece 22 projecting from the notch part 13c is sandwiched by the upper portion of the upper branch tube 13 and the upper portion 26 of the cap member 25, whereby the fixing piece 22 is prevented from moving out from between the upper portion of the cap member 25 and the upper portion of the upper branch tube 13. Accordingly, the fixing piece 22 is strongly fixed and the seal member body 21 is downwardly pressed, thereby downwardly moving from the upper end opening of the upper branch tube 13. Further, the fixing piece 22 and the proximity of the connecting portion of the seal member body 21 and the fixing piece 22 are extended as the seal member body 21 downwardly moves.

Moreover, when the seal member body 21 is located at the upper portion of the upper branch tube 13, the flow path 13a is in the occluded condition. Also, when the flow path 13a of the upper branch tube 13 is used, a flow path 28 communicated with the flow path 13a can be formed within the male luer part 28 by inserting, for example, as shown in FIG. 5, male luer part 28 of a syringe (not shown) into the hole at the center of the upper surface of the cap member 25. In this case, the seal member body 21 is downwardly pressed by the male luer part 28 and moved from the upper end opening of the branch tube 13 to the lower side of wider dimension. Accordingly, the syringe is communicated with the inner of the upper branch tube 13. At that time, the lower end portion of the seal member body 21 also moves with the upper surface of the guide part 17 along an arc.

The upstream branch tube 14 is integrally formed with the chamber part 11 in which a flow path 14a comprised of a tapered hole is formed. This flow path 14a is communicated with a communicating hole 15c and is formed into a tapered shape having a diameter that is gradually reduced closest to the communicating hole 15c and the diameter is gradually increased at the section farthest from the communicating hole 15c. Also, the upstream side portion of the flow path 14a (the right side in FIG. 6) is formed into a tapered shape such that the diameter thereof is gradually increased as closed to the opening of the upstream branch tube 14. Further, a threaded part for connecting collar 14b is provided to the outer peripheral surface of the opening of the upstream branch tube 14.

The valve 30 comprises a generally cylindrical valve body 31 and an operation part 32 connected to the front end of the valve body 31. Also, a ring-like groove 31a which is capable of engaging with the engagement part 11b of the chamber part 11 is formed at the rear end surface of the valve body 31. The valve body 31 is positioned within the chamber part 11 while the groove 31a is engaged with the engagement part 11b of the chamber part 11, whereby the valve body 31 is rotated about the axis of the chamber part 11 by operating the operation part 32. Further, two grooves 33 and 34 are formed on the outer peripheral surface of the valve body 31.

These grooves 33 and 34 are formed so as to communicate with the downstream branch tube 12 and the upstream branch tube 14, respectively. By rotationally operating the valve 30 the downstream branch tube 12 can be communicated with the upstream branch tube 14 through the flow path 13a of the upper branch tube 13 or only one of the downstream branch tube 12 and the upstream branch tube 14 can be communicated with the inside of the chamber part 11 by communicating the grooves 33, 34 with the downstream branch tube 12 or the upstream branch tube 14. Accordingly, when the downstream branch tube 12 is communicated with the upstream branch tube 14 by operating the operational part 32 of the valve 30, the medicinal liquid and the like can flow into the downstream branch tube 12 from the upstream branch tube 14 through the chamber part 11 and the upper branch tube 13.

In this case, the medicinal liquid and the like flowing from the upstream branch tube 14 to the downstream branch tube 12 passes through the flow path 13a at the upper of the chamber part 11, thereby preventing air or the like from accumulating within the chamber part 11 or the flow path 13a. The operational part 32 includes three operating pieces 32a, 32b and 32c formed so as to maintain the angle of 90 degrees to correspond to the downstream branch tube 12, the upper branch tube 13 and the upstream branch tube 14, respectively.

Moreover, as described herein above, the syringe can be detachably mounted to the upper branch tube 13. This syringe includes a medicinal liquid containing part for holding the medicinal liquid and the like and a cylinder-like male luer part 28 of small diameter, in which the inside of the medicinal liquid containing part can be communicated with the flow path 13a of the upper branch tube 13 by inserting the male luer part 28 from the hole at the center of the upper surface of the cap member 25 into the upper branch tube 13. In this case, the seal member body 21 is downwardly pressed by the male luer part 28 and moved down from the upper end opening to the wide portion of the lower side of the upper branch tube as the fixing piece 22 and near portion thereof are extended.

Further, when the front upper end of the seam member body 21 is moved downwardly out of the cylindrical portion forming the upper end opening of the upper branch tube 13, the seal member body 21 is inclined such that the front lower end is located at a position lower than the rear lower end to contact with the front side portion of the guide part 17 (became at higher position). Further, as the male luer part 28 is pressed into the upper branch tube 13, the front lower end of the seal member body 21 is moved from the fore side to the rear side along with the upper surface of the guide part 17. At that time, the front lower end of the seal member body 12 moves along an arc.

Further still, when the male luer part 28 is inserted into the opening of the upper branch tube 13 to position the front lower end of the seal member body 21 at the center portion of the guide part 17 as shown in FIG. 5, the inside of the medicinal liquid container of the syringe is properly communicated with the flow path 13a of the upper branch tube 13. Therefore, the medicinal liquid and the like can flow from the upstream branch tube 14 to the downstream branch tube 12 by communicating the upstream branch tube 14 with the downstream branch tube 12 while another medicinal liquid and the like from the syringe can be mixed with the medicinal liquid and the like. Alternatively, another medicinal liquid and the like can flow from the syringe to the downstream branch tube 12 while the chamber part 11 is blocked from the upstream branch tube 14.

In this configuration, when two different medicinal liquids are supplied to the inside of the body of a patient (not shown), at first, the rear end of a liquid transfusion tube (not shown) equipped with an in-dwelling needle for penetrating and dwelling within the patient is coupled to the downstream branch tube 12. Then, the male luer part provided at the tip end of the liquid transfusion tube extended from a container and the like containing one of the medicinal liquids to be supplied to the patient is connected to the upstream branch tube 14. Next, the male luer part 28 is inserted from the hole at the center on the upper surface of the cap member 25 into the upper branch tube 13 while the other medicinal liquid is suctioned into the medicinal liquid containing part of the syringe.

Then, the medicinal liquid is passed through liquid transfusion lines, including the chamber part 11, and the medicine in the container is delivered to the patient while the in-dwelling needle is penetrated and residing within the body of the patient after all the air within the liquid transfusion lines have been discharged to the outside. Also, the medicinal liquid in the syringe is properly injected into the chamber part 11 through the flow path 13a of the upper branch tube 13. In this case, since all the space within the chamber part 11 becomes a flow path for the medicinal liquid, air is not accumulated therein. Hence, air is prevented from mixing with the medicinal liquid to be supplied to the patient.

When the male luer part 28 is pulled out of the upper branch tube 13 after the completion of the delivery of the medicinal liquid from the syringe, the seal member body 21 is released from the pressure of the male luer part 28 and is returned to the original condition shown in FIG. 4 by the restoring force. Moreover, in accordance with the connector A, since the inside of the upper branch tube 13 is occluded by the seal member 20, the upper branch tube 13 can be occluded and liquid-tight and the generation of bacteria, resulting from the entry of air into the chamber part 11, can be prevented.

Accordingly, in the connector A of one embodiment of the present invention, the seal member 20 comprises the fixing piece 22 fixed at a position between the rear potion of the opening of the upper branch tube 13 and the cap member 25, and the seal member body 21 coupled to the fixing piece 22 for opening and closing the opening of the upper branch tube 13. Also, when the seal member body 21 is positioned within the opening of the upper branch tube 13, the upper branch tube 13 can be sealed therewith and the inner of the chamber part 11 can be communicated with the syringe by inserting the male luer part 28 from the opening side into the inside of the upper branch tube 13 to press the seal member body 21 into the inside of the upper branch tube 13.

Further, the upper branch tube 13 can be occluded at a high level of liquid tightness when the upper branch tube 13 is blocked by the seal member 20, since there is no insertion such as a slit formed therein. Also, because no space for air accumulation is provided to the seal member body 21, the generation of bacteria due to such air accumulation does not easily occur. Moreover, since the seal member body 21 goes into the upper branch tube 13, being guided by the guide part 17 when the seal member body 21 is pressed into the inside of the upper branch tube 13 by the male luer part 28, the position is fixed and the inner of the chamber part 11 and the inner of the syringe are communicated with each other. In this way, proper communication condition between the inner of the chamber part 11 and the inner of the syringe is provided.

The connector in accordance with the invention is not intended to be limited to the above mentioned embodiments; various modifications can be made thereto. For example, while a plug type connector having the valve 30 is employed in each embodiment described herein above, any connector not having a valve wherein the medicinal liquid and the like can be delivered from the upstream branch tube to the downstream branch tube all the time as well as another medicinal liquid and the like can be delivered from the upper branch tube to the chamber part may be employed as a connector of the invention. The connector comprising only the upper branch tube and the downstream branch tube, or one without the upstream branch tube, may be used.

In the connector in accordance with the invention constructed as mentioned in above, the seal member comprises the fixing piece fixed to the predetermined portion at the opening side of the branch tube and the seal member body coupled to the fixing piece for occluding the opening of the predetermined branch tube. Also, when the predetermined branch tube is communicated with the connecting tube, the connecting tube is inserted from the opening of the predetermined branch tube into the inside thereof, thereby pushing the seal member body into the inside of the branch tube to communicate the inner of the camber with the inner of the connecting tube.

According to this, since the need to provide the insertion part comprised by slit and the like to the seal member is eliminated, the branch tube can be occluded at a high level of liquid tightness as the branch tube is occluded. Furthermore, since a space where air may be accumulated is difficult to be formed in the seal member, the generation of bacteria by the accumulation of the air is unlikely to occur. Of the plurality of branch tubes in the present invention, each represents a tube having a liquid flow path extending from the chamber part. Also, any type of connector, for example, an active plug-type having a valve for communicating or blocking the predetermined branch tube, or a regularly communicating type for allowing the flow of liquid medicine between branch tubes, can be employed as the connector in accordance with the invention.

In another embodiment for configuring the connector of the present invention, a guide part is provided at the lower side portion within the predetermined branch tube for guiding the seal member body so as to allow movement along the predetermined track when the seal member body is pushed into the inside of the predetermined branch tube to communicate the inner of the chamber with the inner of the connecting tube.

According to this embodiment, when the seal member body is pushed inside the predetermined branch tube by inserting the connecting tube from the opening of the predetermined branch tube toward the interior, the seal member body enters to the inside of the predetermined branch tube moving along the proper track. Therefore, as the communication of the inner of the chamber with the inner of the connecting tube is obtained the constant position of the seal member body is achieved, thereby providing the proper communication condition between the inner of the chamber and the inner of the connecting tube. Also, the guide part in this case is preferably formed to have the upper surface into a guide surface where the lower end of the seal member body is contacted thereto. More preferably, the guide surface is formed to have an arc-like curved surface tracking a circle about the connecting portion between the fixing piece and the seal member body as a center thereof.

Also, in another configuration of the connector according to the invention, a notch part is formed at the edge of the opening of the predetermined branch tube and the connecting part of the seal member body, and the fixing piece is engaged with that notch part while the fixing piece is protruded from the outer side of the opening, then a cap member is mounted to the outer side of the opening to fix the fixing piece to the predetermined branch tube. By such a construction, the fixing piece can be fixed at the correct and proper position by a simple mechanism.

Further, yet another configurational characteristic of the connector in accordance with one embodiment of the invention is that a valve for communication with any one of the plurality of branch tubes is provided within the chamber. According to this, conditions of communication and occlusion between the liquid transfusion tubes connected to the connector can optionally be switched. Also, the movement of the valve can be rotation about an axis or axial travel.

What is claimed is:

1. A connector comprising a chamber part, a connector body including a plurality of branch tubes extended from said chamber part in different directions, respectively, and a sealing member mounted to one of said plurality of branch tubes;
wherein said seal member comprises a fixing piece fixed to a predetermined portion at an opening side of said one branch tube, and a seal member body coupled to said fixing piece for occluding an opening portion of said one branch tube wherein fluid flow communication between the inner of said chamber with the inner of a connecting tube is formed by inserting said connecting tube from said opening of said one branch tube to the inside thereof pushing said seal member body into the inside of said one branch tube.

2. The connector in accordance with claim 1, wherein a guide part is provided for guiding said seal member body to allow movement along a predetermined track.

3. The connector in accordance with claim 1, wherein a notch part is formed at an edge of said opening of said one branch tube and a connecting part of said seal member body and said fixing piece is engaged with said notch part with said fixing piece protruding from the outer side of said opening, and wherein a cap member is mounted to the outer side of said opening to fix said fixing piece to said one branch tube.

4. The connector in accordance with claim 1, wherein a valve is provided to the inside of said chamber part for communicating between any branch tubes of said plurality of branch tubes by moving within said chamber part.
